(19) United States
(12) Patent Application Publication
(10) Pub. No.: US 2021/0207547 A1
(43) Pub. Date: Jul. 8, 2021

(54) INTAKE VALVE SYSTEM

(71) Applicant: AISAN KOGYO KABUSHIKI KAISHA, Obu-shi, Aichi (JP)

(72) Inventors: Akinari Yasue, Tokai-shi (JP); Mamoru YOSHIOKA, Nagoya-shi (JP)

(21) Appl. No.: 17/055,867

(22) PCT Filed: Mar. 12, 2019
(86) PCT No.: PCT/JP2019/010037

§ 371 Date: Nov. 16, 2020

(30) Foreign Application Priority Data
May 25, 2018 (JP) 2018-100716

(51) Int. Cl. F02D 41/00

(52) U.S. Cl. CPC F02D 41/0002; F02D 2200/04; F02D 2200/101

(57) ABSTRACT

An intake valve system for an engine mounted on a vehicle and generating electric power used by the vehicle. The system includes a valve device having a valve body being moved by a stepping motor; and a controller configured to control a degree of opening of the valve device by supplying to the valve device a request indicating a specific number of steps in which the specific number of steps is a number of steps for driving the engine with a specific characteristic and the stepping motor is to operate according to the specific number of steps, and the controller is configured to control the degree of opening of the valve device by correcting a number of steps when an actual characteristic of the engine is different from the specific characteristic under a situation where the request indicating the specific number of steps is supplied to the valve device.

### TECHNICAL FIELD

The disclosure herein relates to an intake valve system that comprises a valve device disposed in an intake device for an engine that is mounted on a vehicle and configured to generate electric power used by the vehicle.

### BACKGROUND

Japanese Patent Application Publication No. 2012-126194 describes an engine that is mounted on a vehicle and being for electric power generation. A valve device provided with a butterfly valve is disposed on an intake pipe of the engine.

### SUMMARY

In an engine for electric power generation, highly accurate output control may not be required in some cases as compared to an engine for generating traction power. Due to this, an adoption of an intake valve system suitable for air intake for the engine for electric power generation is being considered.

The disclosure herein provides an intake valve system suitable for an engine for electric power generation.

The technique described herein relates to an intake valve system for an engine mounted on a vehicle and configured to generate electric power used by the vehicle. The intake valve system may comprise: a valve device comprising a valve body configured to be moved by a stepping motor; and a controller configured to control a degree of opening of the valve device by supplying to the valve device a request indicating a specific number of steps, wherein the specific number of steps is a number of steps for driving the engine with a specific characteristic and the stepping motor is to operate according to the specific number of steps, wherein the controller is configured to control the degree of opening of the valve device by correcting a number of steps when an actual characteristic of the engine is different from the specific characteristic under a situation where the request indicating the specific number of steps is supplied to the valve device.

In the above configuration, the valve device moves the valve body by using the stepping motor. In the stepping motor, an excitation position of a stator shifts by an instructed number of steps and a rotor thereby rotates. The valve body moves by rotation of the rotor. However, in the stepping motor, there is a possibility that a so-called step-out, in which the rotor does not rotate in synchrony with shifting of the excitation position of the stator, occurs. When the step-out occurs, the rotor does not rotate in synchrony despite the stepping motor being controlled to operate at the specific number of steps, as a result of which the valve body does not open at an intended degree of opening. Due to this, an error could occur between the intended specific characteristic and the actual characteristic of the engine.

In the above configuration, the number of steps is corrected when the actual characteristic of the engine is different from the intended specific characteristic, and the degree of opening of the valve device is thereby controlled. Due to this, the actual characteristic of the engine may be brought closer to the specific characteristic. According to this configuration, the degree of opening of the valve device may be controlled to bring the actual characteristic of the engine closer to the specific characteristic without using sensors for detecting the degree of opening of the valve device and a position of the rotor.

The controller may be configured to control the degree of opening of the valve device by correcting the number of steps when the actual characteristic of the engine is different from the specific characteristic under a situation where the request indicating the specific number of steps is supplied to the valve device and a rotation speed of the engine is maintained constant. According to this configuration, since the rotation speed of the engine is maintained constant, the actual characteristic of the engine may be compared with the specific characteristic while this actual characteristic is stable. Due to this, the number of steps may be corrected so that the actual characteristic may further be brought closer to the intended characteristic of the engine.

A characteristic of the engine includes at least one of an amount of electric power generated by the engine, a rotation speed of the engine, or an amount of air taken into the engine. According to this configuration, the number of steps may suitably be corrected by comparing at least one of the amount of electric power generated by the engine, the rotation speed of the engine, or the amount of air intake the engine.

### BRIEF DESCRIPTION OF DRAWINGS

FIG. 1 shows a schematic view of an electric power system of a vehicle in which an intake device is mounted according to an embodiment.

FIG. 2 shows a schematic diagram of an intake system of the embodiment.

FIG. 3 shows an enlarged cross-sectional view of an upstream side of an intake manifold of the embodiment.

FIG. 4 shows a flowchart of a step number correction process of the embodiment.

FIG. 5 shows a data map indicating a correlated relationship between an amount of electric power generated by the engine and an amount of air taken into the engine of the embodiment.

FIG. 6 shows a data map indicating a correlated relationship between the amount of air taken into the engine and a degree of opening of a valve device for explaining the step number correction process of the embodiment.

### EMBODIMENTS

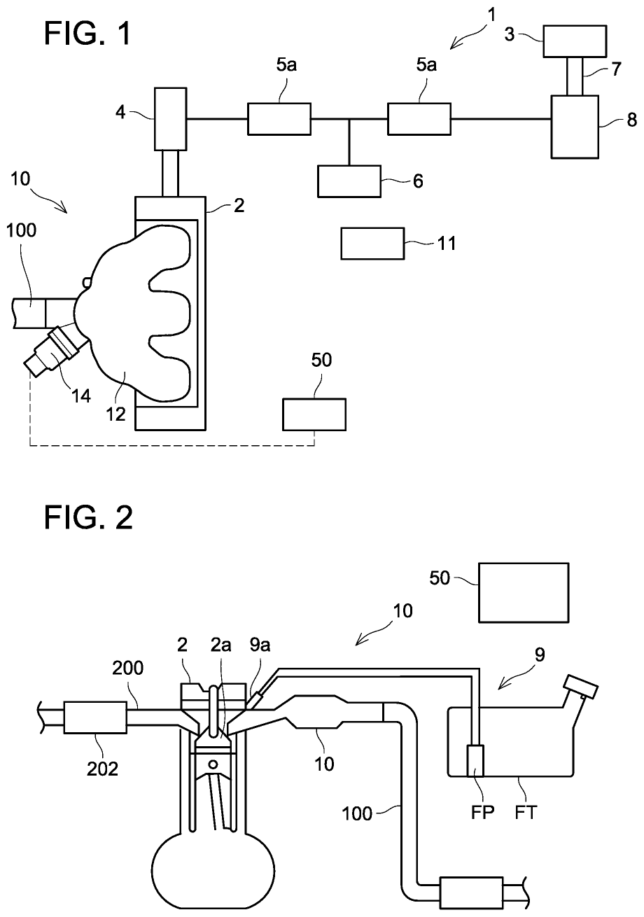

An intake valve system 10 will be described with reference to the drawings. As shown in FIG. 1, the intake valve system 10 is used in an intake system of an engine 2. The engine 2 is mounted on a vehicle 1 such as an automobile, and is used, for example, for supplying electric power to a battery 6 mounted on the vehicle 1.

The vehicle 1 is provided with a traction motor 8, the battery 6 configured to supply electric power to the motor 8, a generator 4 configured to generate the electric power to supply the same to the battery 6, the engine 2 for electric power generation, a fuel supply unit 9 (see FIG. 2) for supplying fuel to the engine 2, and a main controller 11. The vehicle 1 is controlled by the main controller 11. The main controller 11 includes a CPU and a memory. The vehicle 1 may be provided with a traction engine in addition to the engine 2.

The engine 2 is configured to cause the generator 4 to rotate and generate electric power by using the fuel supplied from the fuel supply unit 9. The electric power generated in the generator 4 is used to drive the motor 8. The electric power generated in the generator 4 is supplied to the battery 6 via an inverter 5a and is supplied to the motor 8 via an inverter 5a. The motor 8 is thereby caused to rotate, and rotates a wheel 3 via an axle 7.

As shown in FIG. 2, the fuel supply unit 9 is provided with a fuel tank FT, a fuel pump FP, an injector 9a, and the like. An intake pipe 100 and an exhaust pipe 200 are connected to the engine 2. The intake valve system 10 is disposed between the intake pipe 100 and the engine 2. A catalyst 202 is disposed in the exhaust pipe 200.

(Configuration of Intake Device)

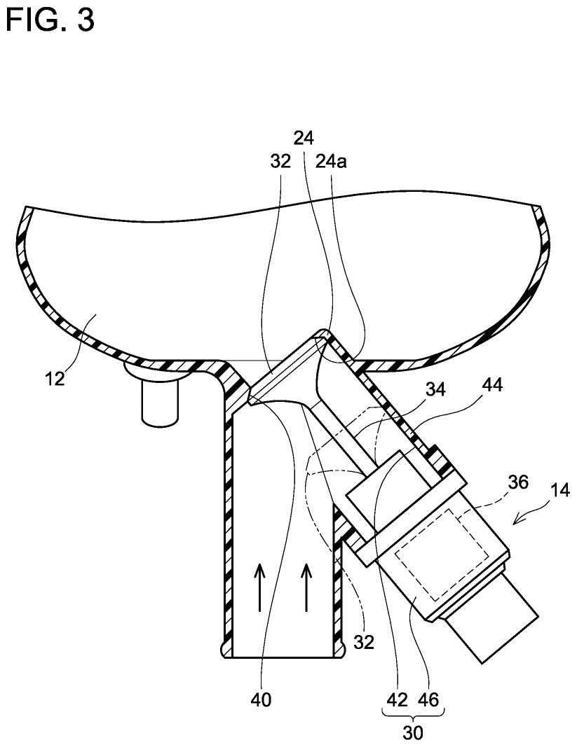

The intake valve system 10 is disposed between the engine 2 and the intake pipe 100. As shown in FIG. 3, the intake valve system 10 is provided with an intake manifold 12, a valve device 14, and an engine control unit 50 (hereinbelow termed “ECU 50”). The intake manifold 12 communicates the intake pipe 100 and a combustion chamber 2a of the engine 2.

The engine 2 is controlled by the ECU 50. The ECU 50 is provided with a CPU and a memory. The ECU 50 is configured to acquire a remaining power level in the battery 6 of the vehicle 1. For example, the ECU 50 may be configured to acquire an output current value from a current sensor configured to detect the output current value of the battery 6 and calculate the remaining power level of the battery 6 using this acquired output current value. The ECU 50 is configured to cause the engine 2 to drive in accordance with the remaining power level of the battery 6 to charge the battery 6 while a system in the vehicle 1 is in an on-state. Due to this, while the system in the vehicle 1 is in the on-state, the engine 2 may be stopped even when the vehicle 1 is traveling.

The valve device 14 is attached to the intake manifold 12. The valve device 14 is provided with a housing 30, a valve body 32, a shaft 34, and a motor 36.

The housing 30 is disposed inclined relative to the intake manifold 12. The housing 30 is provided with a motor housing 46 and a valve guide unit 42. The motor housing 46 is attached to the intake manifold 12. The motor housing 46 is disposed protruding from the intake manifold 12. The valve guide unit 42 is disposed between the motor housing 46 and the intake manifold 12. The valve guide unit 42 is configured integrally with the intake manifold 12 by injected resin. The valve guide unit 42 has a partially cylindrical shape. The valve guide unit 42 is disposed inclined relative to a flow of intake air flowing in the intake manifold 12.

The motor housing 46 houses the motor 36. The motor 36 is provided with a stepping motor configured to rotate by the number of steps indicated by a drive signal sent from the ECU 50. The shaft 34 is attached to the motor 36. The shaft 34 protrudes from the motor housing 46 toward a valve guide unit 42. The shaft 34 is configured to move rectilinearly in an axial direction by the rotation of the motor 36. That is, the shaft 34 progresses and retreats along the axial direction of the shaft 34. Due to this, a length of the shaft 34 protruding from the motor housing 46 is configured to change.

The valve body 32 is attached to a distal end of the shaft 34. When seen along the axial direction of the shaft 34, the valve body 32 has a round shape. The valve body 32 is configured to move in the axial direction of the shaft 34 with rectilinear movement of the shaft 34 so as to come into contact or separate from a valve seat 40. As shown by solid lines in FIG. 3, when the valve body 32 comes into contact with the valve seat 40, communication between the intake pipe 100 and the engine 2 inside the intake manifold 12 is cut off. A state in which the valve body 32 is in contact with the valve seat 40 is termed a fully-closed state.

As the shaft 34 moves rectilinearly from the fully-closed state and a distance between the valve body 32 and the valve seat 40 increases, an area of a clearance between the valve body 32 and the valve seat 40 increases, by which an intake air flow passage area thereby increases. A state in which the valve body 32 is separated from the valve seat 40 at a degree shown by two-dot chain line in FIG. 3 is termed a fully-open state.

In this configuration, a degree of opening of the valve device 14 is controlled by moving the valve body 32 between the fully-closed state and the fully-open state. The flow passage area in the intake manifold 12 changes according to the degree of opening of the valve device 14. Due to this, an amount of air taken into the engine 2 can thereby be controlled. The ECU 50 can control the amount of air taken into the engine 2 by controlling the valve body 32 between the fully-closed state and the fully-open state.

(Operation of Intake Valve System)

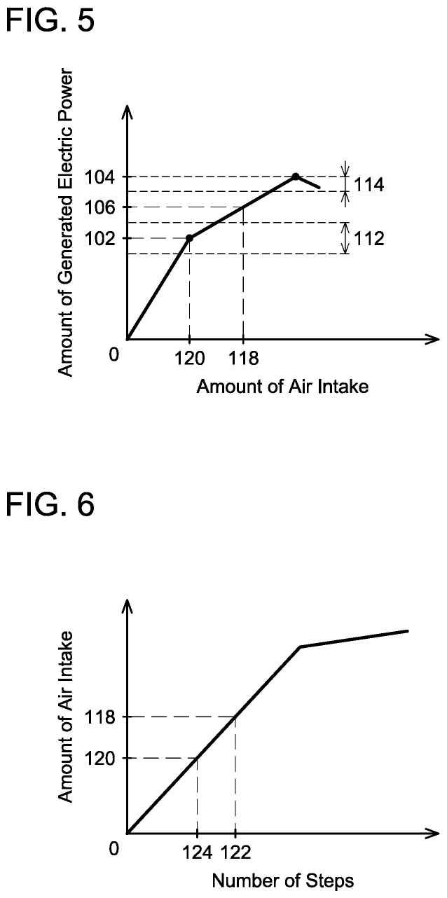

Next, an operation of the intake valve system 10 will be described with reference to FIG. 5. FIG. 5 schematically shows a data map indicating a correlated relationship between an amount of electric power generated by the generator 4 with actuation of the engine 2 and an amount of air taken into the engine 2. A horizontal axis of FIG. 5 shows the amount of air intake and a vertical axis thereof shows the amount of the generated electric power. The data map of FIG. 5 is predetermined by experiments in advance and is stored in the ECU 50. The ECU 50 is configured to control the engine 2 such that the amount of electric power generated by the generator 4 becomes one of two amounts 102, 104 of the generated electric power. The amount 102 of the generated electric power is an amount of the electric power generated in a state where a generation efficiency of the engine 2 (that is, a ratio of the amount of the generated electric power relative to a fuel amount) is highest. The amount 104 of the generated electric power is a maximum amount of the electric power generated by the engine 2.

Under a normal state, the ECU 50 controls the engine 2 such that electric power generation is executed at the amount 102 of the generated electric power. However, in situations where a larger amount of the electric power needs to be generated by the engine 2, such as when a charged level of the battery 6 is low, the ECU 50 controls the engine 2 such that the electric power generation is executed at the amount 104 of the generated electric power. Under a situation in which the engine 2 is to be controlled to generate the amount 102 of the generated electric power, the ECU 50 opens the valve device 14 at a first number of steps. On the other hand, in a situation in which the engine 2 is to be controlled to generate the amount 104 of the generated electric power, the ECU 50 opens the valve device 14 at a second number of steps that is greater than the first number of steps. The first number of steps and the second number of steps are predetermined by experiment and are stored in the ECU 50.

When the ECU 50 supplies a signal indicating the first number of steps or the second number of steps (hereinbelow collectively termed “specific number of steps”) to the valve device 14, the valve device 14 operates the motor 36 by the number of steps indicated by the signal. In doing so, a so-called step-out, in which a rotor does not operate in synchrony with the specific number of steps despite operating a stator by the specific number of steps, could occur in the motor 36 in some cases. When the step-out occurs, the valve device 14 does not open at an intended degree of opening and the amount of the intake air deviates. As shown in FIG. 5, when the amount of the intake air deviates, the amount of the electric power generated by the engine 2 deviates. Further, when the valve body 32 is worn out due to time-related degradation, there may be cases where the valve device 14 does not open at the intended degree of opening despite the rotor operating in synchrony with the specific number of steps, as a result of which the amount of the generated electric power thereby deviates.

(Step Number Correction Process)

In the intake valve system 10, a step number correction process of correcting the number of steps to control the degree of opening of the valve device 14 is executed when the valve device 14 does not open at the intended degree of opening due to the step-out or wear and the amount of the generated electric power thereby deviates.

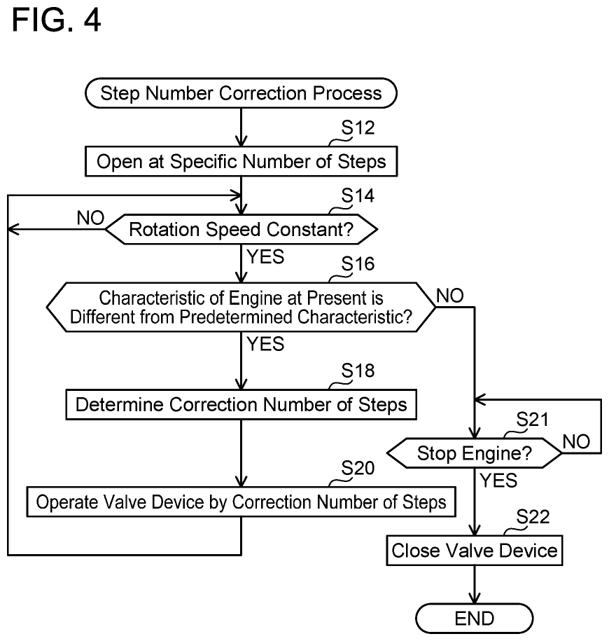

The step number correction process is initiated when the ECU 50 receives a request signal requesting to operate the engine 2 from the main controller 11 of the vehicle. As shown in FIG. 4, in the step number correction process, firstly in S12, the ECU 50 causes the valve device 14 to open at the specific number of steps. Specifically, the ECU 50 sends to the valve device 14 the signal indicating the specific number of steps, which is one of the first number of steps and the second number of steps respectively corresponding to the amount 102 of the generated electric power and the amount 104 of the generated electric power, in accordance with the request signal from the main controller 11. Due to this, the valve device 14 rotates the rotor by the specific number of steps. At this occasion, there is a case where the valve device 14 does not open at the intended degree of opening due to the step-our or wear of the valve body 32.

Next, in S14, the ECU 50 waits until a rotation speed of the engine 2 becomes constant. In a variant, the ECU 50 may, in addition to the rotation speed of the engine 2 or as an alternative thereof, wait until at least one of a load factor of the engine 2 or the amount of electric power generated by the generator 4 becomes constant. When the rotation speed of the engine 2 stabilizes at a constant speed (YES to S14), the ECU 50 determines in S16 whether a characteristic of the engine 2 at present is different from a predetermined characteristic. In the present embodiment, the ECU 50 determines whether or not the actual amount of the electric power generated by the generator 4 in the engine 2 at present is within a predetermined amount range of the generated electric power. The predetermined amount range of the generated electric power differs depending on whether the specific number of steps is the first number of steps or the second number of steps. As shown in FIG. 5, when the specific number of steps is the first number of steps, the predetermined amount range of the generated electric power is a first amount range 112 of the generated electric power, and when the specific number of steps is the second number of steps, the predetermined amount range of the generated electric power is a second amount range 114 of the generated electric power. The first amount range 112 of the generated electric power is a range having a median value being the amount 102 of the generated electric power (that is, the amount of the electric power generated under the state in which the generation efficiency of the engine 2 is the highest). The second amount range 114 of the generated electric power is a range having the amount 104 of the generated electric power (that is, the maximum amount of the electric power generated by the engine 2) as a maximum value. The predetermined amount ranges of the generated electric power are stored in the ECU 50 in advance. The predetermined amount ranges of the generated electric power are ranges of error in the amount of the generated electric power caused by error(s) in the amount of air intake that are caused by factors other than an error in the degree of opening caused by the step-out or wear (such as a manufacture error in the valve device 14 and air pressure), and are allowable error ranges.

When the actual amount of the electric power generated by the generator 4 at present is within the predetermined amount range of the generated electric power, it is determined that the characteristic of the engine 2 at present is not different from the predetermined characteristic (NO to S16), and the process is proceeded to S21. Under the situation where the actual amount of the electric power generated by the generator 4 at present is within the predetermined amount range of the generated electric power, the amount of the generated electric power is approximate to the intended amount of the generated electric power. Due to this, the degree of opening of the valve device 14 does not need to be adjusted.

On the other hand, when the actual amount of the electric power generated by the generator 4 at present is not within the predetermined amount range of the generated electric power, it is determined that the characteristic of the engine 2 at present is different from the predetermined characteristic (YES to S16), and the process is proceeded to S18. In S18, the ECU 50 determines a correction number of steps. Specifically, the ECU 50 determines the correction number of steps by using the data map indicating the correlated relationship between the amount of electric power generated in the generator 4 and the amount of air intake as shown in FIG. 5 and a data map indicating a correlated relationship between the amount of air intake and the number of steps of the valve device 14 as shown in FIG. 6. A horizontal axis of FIG. 6 shows the number of steps and a vertical axis thereof shows the amount of air intake. The data map of FIG. 6 indicating the correlated relationship between the amount of air intake and the number of steps is predetermined by experiments in advance and is stored in the ECU 50.

In addition to the amount of the generated electric power or as an alternative thereof, the ECU 50 may, in regard to the rotation speed of the engine 2 or the amount of air taken into the engine 2, compare the actual rotation speed to an intended rotation speed, compare the actual amount of air intake to an intended amount of air intake, or compare the actual rotation speed and the actual amount of air intake to the intended rotation speed and the intended amount of air intake, respectively. Then, the ECU 50 may determine that the characteristic of the engine 2 at present is different from the predetermined characteristic (YES to S16) when the intended rotation speed is different from the actual rotation speed, when the intended amount of air intake is different from the actual amount of air intake, or when the intended rotation speed and the intended amount of air intake are different from the actual rotation speed and the actual amount of air intake, respectively. Further, the ECU 50 may determine that the characteristic of the engine 2 at present is not different from the predetermined characteristic (NO to S16) when the intended rotation speed is not different from the actual rotation speed, when the intended amount of air intake is not different from the actual amount of air intake, or when the intended rotation speed and the intended amount of air intake are not different from the actual rotation speed and the actual amount of air intake, respectively. The amount of the electric power generated by the engine 2 and the rotation speed of the engine 2 have the correlated relationship. Due to this, when the rotation speed of the engine 2 is to be used as the characteristic of the engine 2, the data map indicating the correlated relationship between the rotation speed of the engine 2 and the amount of air intake may be similar to the data map indicating the correlated relationship between the amount of the electric power generated by the generator 4 due to the actuation of the engine 2 and the amount of air intake as shown in FIG. 5 and may be prepared in advance by experiments. Further, when the amount of air taken into the engine 2 is used as the characteristic of the engine 2, the correction number of steps may be determined by using the data map of FIG. 6. When a plurality of characteristics is used as the characteristic of the engine 2, in S16, YES may be determined in S16 when the characteristic of the engine 2 at present in regard to any one of the plurality of characteristics is different from the corresponding predetermined characteristic (for example, when the rotation speed of the engine 2 is outside a predetermined rotation speed range, or when the amount of air taken into the engine 2 is outside a predetermined amount range of the air intake), and NO may be determined in S16 when the characteristic of the engine 2 at present is not different from the predetermined characteristic for all of the plurality of characteristics. Alternatively, in S16, YES may be determined in S16 when the characteristic of the engine 2 at present is different from the predetermined characteristic for all of the plurality of characteristics, and NO may be determined in S16 when the characteristic of the engine 2 at present in regard to any one of the plurality of characteristics matches the predetermined characteristic for all of the plurality of characteristics.

Hereinbelow, the process of S16 in a case where the predetermined amount range of the generated electric power is the amount range 112 of the generated electric power and the actual amount of the generated electric power is outside the amount range 112 of the generated electric power will be described. Firstly, as shown in FIG. 5, the ECU 50 determines a amount 118 of the air intake corresponding to an actual amount 106 of the electric power generated by the generator 4 at present from the data map indicating the correlated relationship between the amount of the electric power generated by the generator 4 and the amount of air intake. Then, the ECU 50 determines a amount 120 of the air intake corresponding to the amount 102 of the generated electric power being the median in the predetermined amount range 112 of the generated electric power. Then, the ECU 50 determines each of numbers 122, 124 of steps respectively corresponding to the specified two amounts 118, 120 of the air intake from the data map indicating the correlated relationship of the amount of air intake and the number of steps. Then, the ECU 50 determines the correction number of steps by subtracting the specified number of steps 122 from the specified number of steps 124. In a case where the predetermined amount range of the generated electric power is the amount range 114 of the generated electric power, the ECU 50 determines a difference in numbers of steps between the maximum amount 104 of the generated electric power in the amount range 114 of the generated electric power and the actual amount of the generated electric power as the correction number of steps.

Next, in S20, the ECU 50 causes the valve device 14 to operate by the correction number of steps determined in S18 and returns to S14.

In S21, the ECU 50 determines whether or not to stop the engine 2. Specifically, the ECU 50 monitors receipt of a signal requesting to stop the engine 2 from the main controller 11 (NO to S21). When the signal requesting to stop the engine 2 is received from the main controller 11, the ECU 50 determines that the engine 2 is to be stopped (YES to S21) and proceeds to S22. In S22, the ECU 50 closes the valve device 14 to the fully-closed state and terminates the step number correction process. When the fully-closed state is realized, the ECU 50 causes the valve device 14 to execute an initialization operation. In the initialization operation, the motor 36 is controlled to be in its initial state while the valve device 14 being in the fully-closed state (that is, a state in which the rotor is disposed at a preset initial position.)

(Effects)

In the step number correction process, the number of steps is corrected in the case where the actual characteristic of the engine 2 is different from the intended specific characteristic thereof, and the degree of opening of the valve device 14 is thereby controlled. Due to this, the actual characteristic of the engine 2 can be brought closer to the specific characteristic. According to this configuration, the degree of opening of the valve device 14 can be controlled to bring the actual characteristic of the engine 2 closer to the specific characteristic without using sensors for detecting the degree of opening of the valve device 14 or the rotor position.

Further, in the step number correction process, since the rotation speed of the engine 2 is maintained constant, the control of the degree of opening can be executed while the actual characteristic of the engine 2 is stable. Due to this, the number of steps can suitably be corrected so as to realize the characteristic closer to the intended characteristic of the engine 2.

(Corresponding Relationship)

The amount 106 of the generated electric power is an example of “actual characteristic of the engine” and the amount ranges 112, 114 of the generated electric power are examples of “specific characteristic”. The amount 106 of the generated electric power being outside the amount range 112 of the generated electric power (YES to S16) is an example of “when an actual characteristic of the engine is different from the specific characteristic”.

Specific examples of the present disclosure have been described in detail, however, these are mere exemplary indications and thus do not limit the scope of the claims. The art described in the claims include modifications and variations of the specific examples presented above.

(1) The valve device 14 of the embodiment is a so-called poppet valve in which the shaft 34 and the valve body 32 move rectilinearly. However, the configuration of the valve device 14 is not limited to this configuration, and may be a butterfly valve configured to be operated by a stepping motor.

(2) In the step number correction process of the embodiment, the characteristic of the engine 2 is compared (S16) and the correction number of steps is determined (S18) under the situation in which the rotation speed is maintained constant (YES to S14). However, the characteristic of the engine 2 may be compared and the correction number of steps may be determined under a situation in which the rotation speed is not maintained constant. In this variant, the characteristic of the engine 2 may be compared and the correction number of steps may be determined under a situation in which the load factor of the engine 2 is maintained constant. Alternatively, under a situation in which the rotation speed of the engine 2 is not maintained constant, the characteristic of the engine 2 which varies according to changes in the rotation speed of the engine 2 may be compared.

Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

1. An intake valve system for an engine mounted on a vehicle and configured to generate electric power used by the vehicle, the intake valve system comprising:
a valve device comprising a valve body configured to be moved by a stepping motor; and
a controller configured to control a degree of opening of the valve device by supplying to the valve device a request indicating a specific number of steps, wherein the specific number of steps is a number of steps for driving the engine with a specific characteristic and the stepping motor is to operate according to the specific number of steps, wherein
the controller is configured to control the degree of opening of the valve device by correcting a number of steps when an actual characteristic of the engine is different from the specific characteristic under a situation where the request indicating the specific number of steps is supplied to the valve device.

2. The intake valve system as in claim 1, wherein
the controller is configured to control the degree of opening of the valve device by correcting the number of steps when the actual characteristic of the engine is different from the specific characteristic under a situation where the request indicating the specific number of steps is supplied to the valve device and a rotation speed of the engine is maintained constant.

3. The intake valve system as in claim 1, wherein
a characteristic of the engine includes at least one of an amount of electric power generated by the engine, a rotation speed of the engine, or an amount of air taken into the engine.
